(19) United States
(12) Patent Application Publication
(10) Pub. No.: US 2014/0351864 A1
(43) Pub. Date: Nov. 27, 2014

(54) TELEVISION BROADCAST RECEIVER

(71) Applicant: Sanyo Electric Co., Ltd., Moriguchi-shi, Osaka (JP)

(72) Inventors: Itsumi Tateishi, Moriguchi-shi (JP); Nobutoshi Oki, Moriguchi-shi (JP)

(21) Appl. No.: 14/345,575

(22) PCT Filed: Nov. 12, 2012
(86) PCT No.: PCT/JP2012/079197

§ 371 Date: Mar. 18, 2014

(30) Foreign Application Priority Data
Dec. 22, 2011 (JP) 2011-281976

(51) Int. Cl. H04N 21/485; H04N 21/482; H04N 21/4782; H04N 21/61; H04N 21/45; H04N 21/422; H04N 5/44

(52) U.S. Cl. CPC H04N 21/485; H04N 21/42204; H04N 21/482; H04N 5/4403; H04N 21/6125; H04N 21/6175; H04N 21/4516; H04N 21/4782
USPC 725/59

(57) ABSTRACT

The control portion of a television broadcast receiver individually processes, in a pseudo manner, a network application as one of choices of an “input target” and/or a “reception channel” and starts up, when the choice of the “input target” and/or the “reception channel” corresponding to the network application is selected, the network application corresponding to the “input target” and/or the “reception channel” that has been selected.

### TECHNICAL FIELD

The present invention relates to a television broadcast receiver, and more particularly relates to a television broadcast receiver that has the network function of providing various types of services via the Internet. The television broadcast receiver includes not only a television set but also an STB (set top box) that has no monitor unlike the television set and the like.

### BACKGROUND ART

In recent years, some television broadcast receivers have the network function of providing various types of services via the Internet. The service provided by the network function can be realized as a result of the television broadcast receiver starting up a network application. The television broadcast receiver having the network function corresponds to a plurality of network applications, and the service provided by the network function differs for each network application and is provided by a different company for each network application.

### RELATED ART DOCUMENT

### Patent Document

Patent document 1: International publication No. 2007/043483

### SUMMARY OF THE INVENTION

### Problems to be Solved by the Invention

In a conventional television broadcast receiver having the network function, as a method of starting up a network application, the following methods are adopted.

A first method is as follows: a special key for starting up a specific network application is provided in a remote control transmitter attached to the television broadcast receiver and a user operates the special key to start up the specific network application.

A second method is as follows: on a menu screen showing a list of various types of operation items, selection items for displaying a network portal screen displaying a list of network applications are provided, the user operates a menu key provided in the remote control transmitter attached to the television broadcast receiver or the main body of the television broadcast receiver and thereby stats up the menu screen, then the user operates a selection key provided in the remote control transmitter attached to the television broadcast receiver and thereby selects the selection item for displaying the network portal screen to start up the network portal screen and finally, the user operates the selection key provided in the remote control transmitter attached to the television broadcast receiver and thereby starts up the desired network application.

A third method is as follows: a special key for displaying the network portal screen is provided in the remote control transmitter attached to the television broadcast receiver, the user operates the special key to start up the network portal screen and then the user operates the selection key provided in the remote control transmitter attached to the television broadcast receiver and thereby starts up the desired network application.

In the first and third methods, it is disadvantageously necessary to provide the special key in the remote control transmitter attached to the television broadcast receiver. In particular, in the first method, as the number of network applications is increased, the number of special keys is increased, with the result that it is difficult for the side of the remote control transmitter to perform a satisfactory operation.

In the second method, since it is necessary to perform the procedure through the menu screen and the network portal screen, disadvantageously, a large number of steps in the procedure to reach the desired network application are needed and the procedure is complicated.

Although in patent document 1, content on a network is allocated to a channel, and based on a given rule, the content is collectively handled every channel group, which is a given handing unit, since it is necessary to select a desired channel group, disadvantageously, a large number of steps in the procedure to reach the desired network application are needed and the procedure is complicated.

In view of the foregoing conditions, an object of the present invention is to provide a television broadcast receiver that can easily select a desired network application without provision of a special key.

### Means for Solving the Problem

According to the present invention, there is provided a television broadcast receiver including: a control portion which sets an “input target” and a “reception channel”; an input terminal through which a video stream output by an external device is input; and a broadcast reception portion which performs, on a television broadcast signal, channel selection processing corresponding to the “input target” and the “reception channel” set by the control portion, where the television broadcast receiver has, as a choice of the “input target”, a plurality of choices including a choice corresponding to the input terminal and a choice corresponding to the broadcast reception portion, the television broadcast receiver starts up a network application such that the television broadcast receiver can provide a service provided via the Internet and the control portion individually processes, in a pseudo manner, the network application as one of choices of the “input target” and/or the “reception channel” and starts up, when the choice of the “input target” and/or the “reception channel” corresponding to the network application is selected, the network application corresponding to the “input target” and/or the “reception channel” that has been selected.

Preferably, a list of the choices of the “input target” can be displayed on a display.

Preferably, the order in which the choices of the “input target” corresponding to the network applications are arranged is changed according to a frequency of selection of the network application.

Preferably, a channel number to which a broadcast station that can be received is not allocated by presetting the reception channel is individually allocated to the network application.

### Effects of the Invention

In the television broadcast receiver of the present invention, since each network application is processed as one of the choices of the “input target” and/or the “reception channel” in a pseudo manner, the network application can be selected (started up) by the same operation as the operation of switching the “input target” or the operation of switching the “reception channel”. In other words, it is possible to easily select the desired network application without provision of a special key.

The significance and effects of the present invention will be further clarified by the description of embodiments below. However, each of the following embodiments is simply one embodiment of the present invention; the significance of the terms of the present invention or each constituent requirement is not limited to the embodiments described below.

### BRIEF DESCRIPTION OF DRAWINGS

FIG. 1 A block diagram of a television broadcast receiver;

FIG. 2 A front view of a remote control transmitter attached to the television broadcast receiver; and

FIG. 3 A diagram showing an example of the display screen of the television broadcast receiver.

### DESCRIPTION OF EMBODIMENTS

Embodiments of the present invention will be described below with reference to accompanying drawings.

### First Embodiment

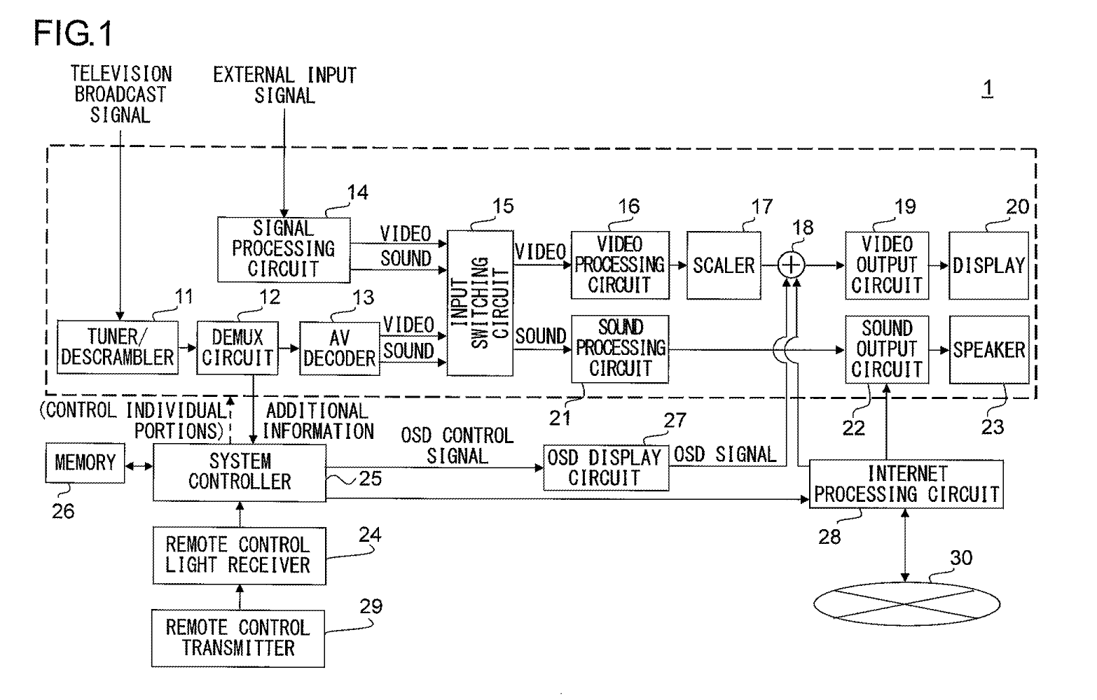

FIG. 1 is a block diagram of a television broadcast receiver 1. The television broadcast receiver 1 is a television set having the Internet connection function, and includes, as shown in FIG. 1, a tuner/descrambler 11, a DEMUX circuit 12, an AV decoder 13, a signal processing circuit 14, an input switching circuit 15, a video processing circuit 16, a scaler 17, a composite circuit 18, a video output circuit 19, a display 20, a sound processing circuit 21, a sound output circuit 22, a speaker 23, a remote control light receiver 24, a system controller 25, a memory 26, an OSD (on-screen display) display circuit 27 and an Internet processing circuit 28. A remote control transmitter 29 for remotely operating the television broadcast receiver 1 is attached to the television broadcast receiver 1. A user operates the remote control transmitter 29, and thereby can operate the television broadcast receiver 1 remotely.

The television broadcast receiver 1 has, as the choices of an “input target”, “terrestrial digital broadcast”, “satellite digital broadcast”, a “HDMI (high definition multimedia interface) 1”, a “HDMI2” and “HDMI3”.

The tuner/descrambler 11 performs processing (channel selection processing) for extracting signals corresponding to the “input target” and a “reception channel” that are currently set, on television broadcast signals transmitted through an antenna or the like, and also performs predetermined high-frequency processing, scramble cancellation processing, demodulation processing and the like. The signals obtained by these types of processing are fed out to the DEMUX circuit 12 as a packet. The “input target” and the “reception channel” can be switched by the system controller 25.

The DEMUX circuit 12 decodes the packet received from the tuner/descrambler 11. Here, the packet is classified, by the DEMUX circuit 12, into MPEG data indicating the content of a television program and additional information. Then, the MPEG data consisting of a video stream and a sound stream and the additional information are fed out to the AV decoder 13 and the system controller 25, respectively. The additional information is, for example, guide information on a television program that is currently being broadcast or that will be broadcast in the future or information such as a notice from a broadcaster, and is broadcast together with information on the content of the television program every predetermined time interval.

The AV decoder 13 decodes the MPEG data received from the DEMUX circuit 12 into a video signal and a sound signal, and feeds out the video signal and the sound signal to the input switching circuit 15.

Based on an external input signal (the video stream and the sound stream) corresponding to the “input target” which is currently set, the signal processing circuit 14 acquires the video signal and the sound signal indicating the content. The signal processing circuit 14 feeds out the video signal and the sound signal acquired to the input switching circuit 15.

Among the video signal and the sound signal transmitted from the side of the preceding stage, the input switching circuit 15 transmits only signals corresponding to the “input target” which is currently set, to a circuit on the side of the subsequent stage.

Specifically, when the “terrestrial digital broadcast” or the “satellite digital broadcast” is set at the “input target”, the input switching circuit 15 transmits the video signal and the sound signal transmitted from the AV decoder 13 to the video processing circuit 16 and the sound processing circuit 21, respectively. On the other hand, when the “HDMI1”, the “HDMI2” or the “HDMI3” is set at the “input target”, the video signal and the sound signal transmitted from the signal processing circuit 14 are transmitted to the video processing circuit 16 and the sound processing circuit 21, respectively.

The video processing circuit 16 performs various types of processing on the video signal received from the input switching circuit 15, and feeds it out to the scaler 17. The processing performed by the video processing circuit 16 includes various types of processing on image quality adjustment (for example, contract adjustment, brightness adjustment and sharpness adjustment).

The scaler 17 feeds out, according to an instruction from the system controller 25, the video signal received from the video processing circuit 16 without the video signal being processed, to the composite circuit 18. Alternatively, the scaler 17 performs processing (small-screen conversion processing) for displaying the video on a small screen on the video signal received from the video processing circuit 16, and feed it out to the composite circuit 18.

The composite circuit 18 receives the video signal, an OSD signal and a network content video signal from the scaler 17, the OSD display circuit 27 and the Internet processing circuit 28, respectively, and feeds out any one of these signals to the video output circuit 19. Alternatively, the composite circuit 18 generates a display signal indicating content obtained by combining (overlaying) at least two items of display content among these signals, and feeds it out to the video output circuit 19.

The video output circuit 19 feeds out the received display signal to the display 20, and displays the content of the display signal on the display 20. As the display 20, various types of displays such as a CRT (cathode ray tube) and a liquid crystal display can be adopted.

The sound processing circuit 21 performs necessary predetermined processing on the sound signal received from the input switching circuit 15, and feeds it out to the sound output circuit 22. The sound output circuit 22 feeds out the received sound signal to the speaker 23, and outputs sound based on the sound signal through the speaker 23.

The remote control light receiver 24 receives an infrared signal transmitted from the remote control transmitter 29, converts it into an electrical signal including a remote control code and transmits it to the system controller 25.

The system controller 25 controls the individual portions of the television broadcast receiver 1 according to operations by the user on a plurality of types of operation keys (not shown) provided in the television broadcast receiver 1 and on a plurality of types of operation keys provided in the remote control transmitter 29. The memory 26 stores a data table indicating the relationship between the operation keys and the remote control codes and information such as various types of OSD display screen data. The memory 26 also stores information on network applications.

The OSD display circuit 27 receives an OSD control signal including an OSD display screen from the system controller 25, generates the OSD signal based on this control signal and feeds it out to the composite circuit 18.

The Internet processing circuit 28 has the function of connecting to the Internet 30, receives the provision of network content via the Internet 30 from a predetermined server, feeds out the video signal of the network content to the composite circuit 18 and feeds out the sound signal of the network content to the sound output circuit 22.

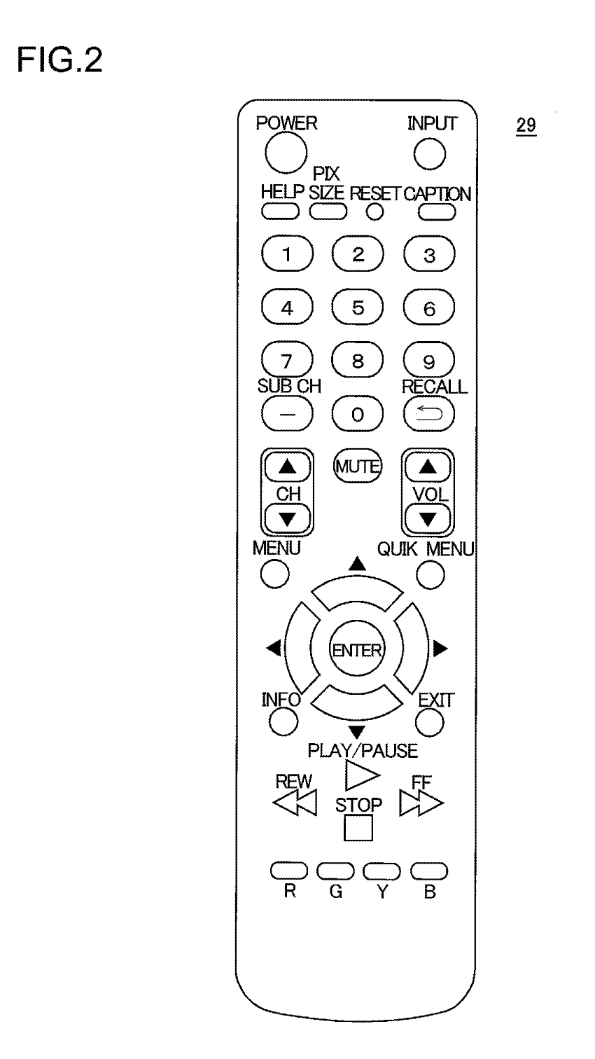

On the front surface of the remote control transmitter 29, as shown in FIG. 2, a “power supply (POWER)” key, an “input switching (INPUT)” key, a “channel (CH) +” key, a “channel (CH)−” key, a “menu (MENU)” key, numerical keys (“0” to “9”), a selection key (“up”, “down”, “right”, “left” and “ENTER”), a “cancellation (RECALL)” key, an “exit (EXIT)” key and the like are provided.

The “input switching” key is an operation key for switching the “input target” described above. The “channel +” key is an operation key for switching the reception channel in ascending order, and the “channel −” key is an operation key for switching the reception channel in descending order. The “menu” key is an operation key for alternately switching the operation mode of the television broadcast receiver 1 between a normal mode and a menu mode.

Operations of the television broadcast receiver 1 related to the present invention will now be described.

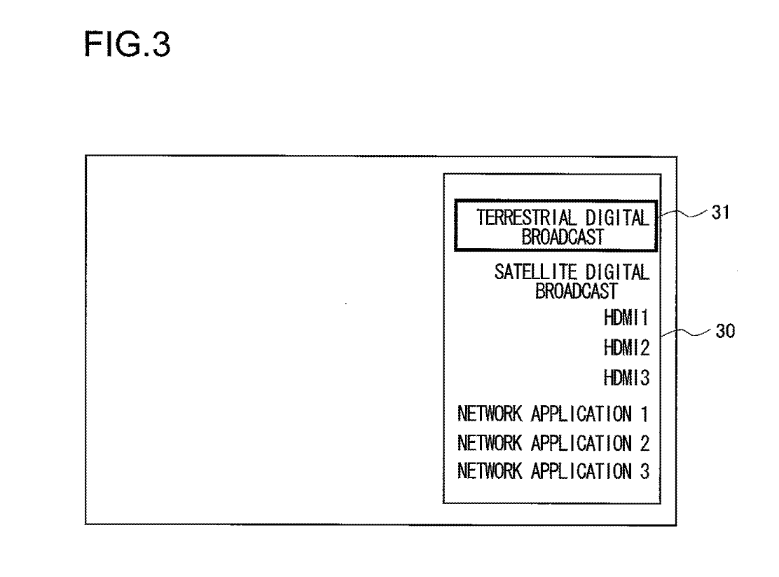

When the “input switching (INPUT)” key provided in the television broadcast receiver 1 or the remote control transmitter 29 is pressed down by the user, as shown in FIG. 3, the display 20 displays an input list 30. The input list 30 includes not only the choices of the actual “input target”, that is, the “terrestrial digital broadcast”, the “satellite digital broadcast”, the “HDMI1”, the “HDMI2” and “HDMI3” but also the list of network applications (in the present embodiment, it is assumed that there are a “network application 1”, a “network application 2” and a “network application 3”). A cursor 31 in the input list 30 can be moved sequentially with a method of pressing down, by the user, the “up” key or the “down” key provided in the remote control transmitter 29 or with a method of pressing down again, by the user, the “input switching (INPUT)” key provided in the television broadcast receiver 1 or the remote control transmitter 29.

For example, when with the cursor 31 located in the “HDMI1”, the user presses down the “ENTER” key provided in the remote control transmitter 29, the “input target” is set at the “HDMI1”.

For example, when with the cursor 31 located in the “network application 1”, the user presses down the “ENTER” key provided in the remote control transmitter 29, the “network application 1” is started up, and the list of serves (content) that can be provided by the “network application 1” is displayed.

As described above, the system controller 25 of the television broadcast receiver 1 processes each network application as one of the choices of the “input target” in a pseudo manner. Thus, since the network application can be selected by the same operation as the input switching, it is possible to easily select the desired network application without provision of a special key.

Instead of the “terrestrial digital broadcast”, the individual channels of the “terrestrial digital broadcast” may be included in the input list 30. Likewise, instead of the “satellite digital broadcast”, the individual channels of the “satellite digital broadcast” may be included in the input list 30.

With respect to the individual network applications included in the input list 30, addition or deletion can be preferably performed such as by setting on the menu screen. A network application having a higher frequency of selection is displayed more upwardly in the list, and thus a network application having a higher frequency of selection may be easily selected. In this case, the frequency of selection of each network application is stored in the memory 26, the details stored are utilized by the system controller 25 and thus it is possible to display a network application having a higher frequency of selection more upwardly in the list without performing a special operation by the user.

Without display of the input list 30, for example, each time the “input switching (INPUT)” key is pressed down by the user, the “terrestrial digital broadcast”, the “satellite digital broadcast”, the “HDMI1”, the “HDMI2”, “HDMI3”, the “network application 1”, the “network application 2” and the “network application 3” may be switched sequentially.

### Second Embodiment

Points different from the first embodiment described above will be described, and the description of the same points as in the first embodiment will be omitted.

In a general television broadcast receiver, the reception channel is preset, and thus a channel number is allocated to a broadcast station which can be received, with the result that channel numbers to which the broadcast station which can be received is not allocated are empty numbers.

In the television broadcast receiver 1, channel numbers that are empty numbers are allocated to individual network applications, and the results of the allocation are stored in the memory 26. For example, when the network applications which can be utilized by the television broadcast receiver 1 are assumed to be three network applications, that is, the “network application 1”, the “network application 2” and the “network application 3”, and channel numbers that are empty numbers are “555”, “666”, “777” and the like, it is preferable that the channel “555” be allocated to the “network application 1”, the channel “666” be allocated to the “network application 2” and the channel “777” be allocated to the “network application 3”.

When the reception channel is selected by directly inputting (directly switching) the channel with the “numerical” keys provided in the remote control transmitter 29 or by switching the channel with the “channel +” key and the “channel −” key provided in the television broadcast receiver 1 or the remote control transmitter 29, a broadcast program corresponding to the selected channel can be viewed whereas when the channel to which the network application is allocated is selected, the network application corresponding to the selected channel is started up, and the list of the services (content) that can be provided by the network application started up is displayed.

As described above, the system controller 25 of the television broadcast receiver 1 processes each network application as one of the choices of the “reception channel” in a pseudo manner. Thus, since it is possible to select the network application with the same operation as the channel switching, it is possible to easily select the desired network application without provision of a special key.

The present embodiment can be practiced together with the first embodiment described above.

### INDUSTRIAL APPLICABILITY

The present invention can be utilized for television broadcast receivers.

### LIST OF REFERENCE SYMBOLS

1 television broadcast receiver
11 tuner/descrambler
12 DEMUX circuit
13 AV decoder
14 signal processing circuit
15 input switching circuit
16 video processing circuit
17 scaler
18 composite circuit
19 video output circuit
20 display
21 sound processing circuit
22 sound output circuit
23 speaker
24 remote control light receiver
25 system controller
26 memory
27 OSD display circuit
28 Internet processing circuit
29 remote control transmitter
30 input list
31 cursor

1. A television broadcast receiver comprising:
a control portion which sets an “input target” and a “reception channel”;
an input terminal through which a video stream output by an external device is input; and
a broadcast reception portion which performs , on a television broadcast signal, channel selection processing corresponding to the “input target” and the “reception channel” set by the control portion,
wherein the television broadcast receiver has, as a choice of the “input target”, a plurality of choices including a choice corresponding to the input terminal and a choice corresponding to the broadcast reception portion,
the television broadcast receiver starts up a network application such that the television broadcast receiver can provide a service provided via the Internet and
the control portion individually processes, in a pseudo manner, the network application as one of choices of the “input target” and/or the “reception channel” and
starts up, when the choice of the “input target” and/or the “reception channel” corresponding to the network application is selected, the network application corresponding to the “input target” and/or the “reception channel” that has been selected.

2. The television broadcast receiver of claim 1,
wherein a list of the choices of the “input target” can be displayed on a display.

3. The television broadcast receiver of claim 1,
wherein an order in which the choices of the “input target” corresponding to the network applications are arranged is changed according to a frequency of selection of the network application.

4. The television broadcast receiver of claim 1,
wherein a channel number to which a broadcast station that can be received is not allocated by presetting the reception channel is individually allocated to the network application.
